(19) United States
(12) Patent Application Publication
(10) Pub. No.: US 2015/0110526 A1
(43) Pub. Date: Apr. 23, 2015

(54) DEVELOPER SUPPLY CONTAINER AND IMAGE FORMING APPARATUS

(71) Applicant: CANON KABUSHIKI KAISHA, Tokyo (JP)

(72) Inventors: Takayuki Tanaka, Tokyo (JP); Shinichi Nishida, Kawasaki-shi (JP); Masashige Tamura, Kawasaki-shi (JP); Takeshi Fujino, Yokohama-shi (JP); Junji Yasuda, Kawasaki-shi (JP); Kazuaki Takahata, Kawasaki-shi (JP); Satoru Nitobe, Tokyo (JP); Fuyuko Koyama, Yokohama-shi (JP)

(21) Appl. No.: 14/515,737

(22) Filed: Oct. 16, 2014

(30) Foreign Application Priority Data
Oct. 17, 2013 (JP) 2013-216064

(51) Int. Cl. G03G 15/08

(52) U.S. Cl. CPC G03G 15/0874
USPC 399/262

(57) ABSTRACT

A developer supply container includes: a developer accommodating bag, having an elastic restoring force, for accommodating the developer; and a developer discharging path for discharging, when the developer accommodating bag is mounted in a main assembly of an image forming apparatus, the developer accommodated in the developer accommodating bag to the main assembly. When the developer accommodating bag is mounted in the main assembly, the developer accommodating bag is expandable by pressure generating means provided in the main assembly. An amount of the developer accommodated in the developer accommodating bag is such that by accommodation of the developer, a volume of the developer accommodating bag is not less than a volume when a contraction pressure of the developer accommodating bag has a maximum value.

### FIELD OF THE INVENTION AND RELATED ART

The present invention relates to a developer supply container, for supplying a developer, provided detachably mountable by an image forming apparatus, such as a copying machine, a printer or a facsimile machine, in which an image is formed by an electrophotographic process, and relates to the image forming apparatus including the developer supply container.

In most of the image forming apparatus of an electrophotographic type, the developer formed in powder is used and is gradually consumed in a developing device with image formation. Then, when the developer in the developing device is consumed in a service life period of the developing device, the detachably mountable developer supply container is mounted in the image forming apparatus, and then the developer is fed from the developer supply container into the developing device.

In order to feed the developer from the developer supply container into the developing device, in some cases, a stirring and feeding member such as a screw is used in the developer supply container. The developer supply container is a species of so-called consumables, and is discarded as an empty container after use or is recycled after being disassembled every component. In recent years, in view of environment, design such that the number of components of the developer supply container as the consumables is made small has been desired.

For example, in Japanese Laid-Open Patent Application (JP-A) Sho 60-232578, as the developer supply container small in the number of components, a developer accommodating bag accommodating the developer is formed of an elastic material capable of expansion and contraction. The developer accommodating bag contains air and the developer, which is fluidized, filled therein, and the developer is fed into the developing device by a restoring force of the developer accommodating bag.

In the case of the developer supply container in which the developer accommodating bag formed of the elastic material capable of expansion and contraction contains the air and the fluidized developer filled therein, there arises the following problem. That is, in general, the elastic material capable of expansion and contraction is high in gas permeability, and therefore in the case a long term elapses from manufacturing of the developer supply container until the developer supply container is used, the air inside the elastic material leaks out. Then, correspondingly to a decrease in air in the developer accommodating bag, the elastic material contracts, so that the restoring force of the elastic material lowers.

For this reason, in the developer supply container for which the long term elapsed from the manufacturing thereof to the use thereof, a developer discharging performance lowers. In order to restore this lowering in developer discharging performance, a pump for supplying the air into the developer supply container is provided in the image forming apparatus in some cases.

The pump is required to generate a pressure higher than a contraction pressure by a restoring force of the developer accommodating bag in order to expand the developer accommodating bag. Particularly, the developer accommodating bag formed of the elastic material capable of expansion and contraction has a maximum value of the pressure in a region in which the developer accommodating bag starts the expansion. The pump is required to generate a high pressure exceeding this maximum value, so that the pump was upsized.

### SUMMARY OF THE INVENTION

A principal object of the present invention is to provide a developer supply container capable of decreasing a force for expanding a developer accommodating bag.

According to the present invention, a generation pressure required for a pump is reduced, so that the pump can be downsized.

According to an aspect of the present invention, there is provided a developer supply container, detachably mountable to a main assembly of an image forming apparatus for forming an image with a developer, for supplying the developer to the main assembly, the developer supply container comprising: a developer accommodating bag, having an elastic restoring force, for accommodating the developer; and a developer discharging path for discharging, when the developer accommodating bag is mounted in the main assembly, the developer accommodated in the developer accommodating bag to the main assembly, wherein when the developer accommodating bag is mounted in the main assembly, the developer accommodating bag is expandable by pressure generating means provided in the main assembly, and wherein an amount of the developer accommodated in the developer accommodating bag is such that by accommodation of the developer, a volume of the developer accommodating bag is not less than a volume when a contraction pressure of the developer accommodating bag has a maximum value.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an image forming apparatus in First Embodiment of the present invention.

FIG. 2 is a schematic sectional view of a process cartridge in First Embodiment.

FIG. 3 is a schematic sectional view of a toner cartridge in First Embodiment.

FIG. 4 is a schematic view of an outer appearance of the image forming apparatus in First Embodiment.

FIG. 5 is a perspective view showing an outer appearance of the image forming apparatus in First Embodiment.

In FIG. 6, (a) is a schematic sectional view showing a mounting state between the toner cartridge and the image forming apparatus in First Embodiment, and (b) is a graph showing modes of an operation of the image forming apparatus in First Embodiment.

FIG. 7 is a graph showing a relationship between an internal (inside) pressure and a radius of a toner accommodating bag in First Embodiment.

FIG. 8 is a graph showing a relationship between a filled air amount and a generated pressure by a pump in the case where a filled toner amount is changed in First Embodiment.

FIG. 9 is a graph showing a relationship between the filled toner amount and a maximum generated pressure by the pump during filling in First Embodiment.

FIG. 10 is a graph showing a relationship between the filled toner amount and a weight of a toner remaining in the toner accommodating bag (remaining toner amount) when the toner in the toner accommodating bag is discharged while changing the filled toner amount in First Embodiment.

FIG. 11 is a schematic sectional view of a toner cartridge in Second Embodiment of the present invention.

FIG. 12 is a schematic view of an outer appearance of the toner cartridge in Second Embodiment.

In FIG. 13, (a) is a schematic sectional view showing a mounting state between the toner cartridge and the a main of an image forming apparatus in Second, and (b) is a graph showing modes of an operation of the image forming apparatus in second Embodiment.

FIG. 14 is a graph showing a relationship between a filled air amount and a generated pressure by a pump in the case where a filled toner amount is changed in Second Embodiment.

### DESCRIPTION OF THE EMBODIMENTS

Hereinbelow, embodiments of the present invention will be specifically described with reference to the drawings.

In the following, an image forming apparatus according to the present invention will be further specifically described in conformity with the drawings. However, dimensions, materials and shapes of constituent elements and their relative arrangements and the like described in the following embodiments should be changed appropriately depending on structures and various conditions of accommodates (devices) to which the present invention is applied, and the scope of the present invention is not intended to be limited to the following embodiments.

### Embodiment 1

### General Structure of Image Forming Apparatus

First, a general structure of the image forming apparatus in this embodiment will be described.

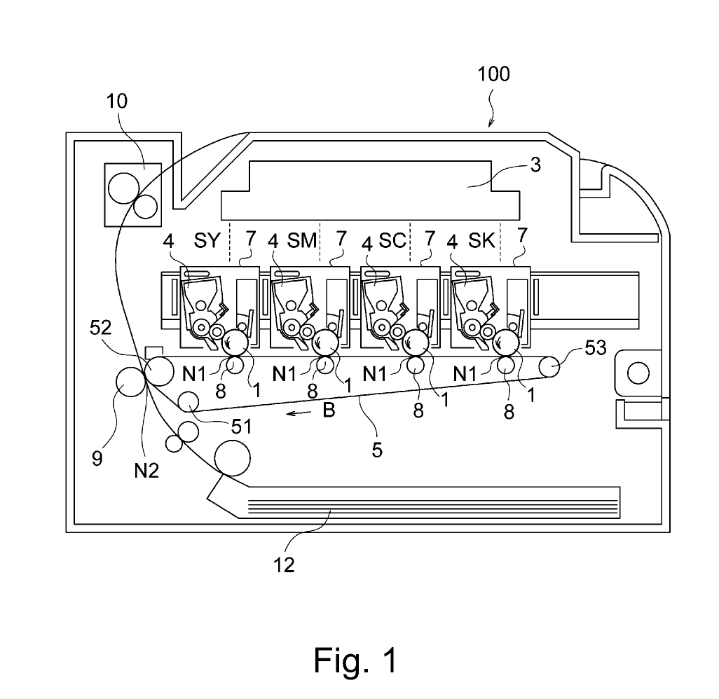

FIG. 1 is a schematic sectional view of an image forming apparatus 100.

The image forming apparatus 100 is a full-color laser beam printer employing an in-line type and an intermediary transfer type, and is capable of forming a full-color image, in accordance with image information, on a recording material 12 such as a recording sheet, a plastic sheet or cloth.

The image forming apparatus 100 includes, as a plurality of image forming portions, image forming portions SY, SM, SC and SK for forming images of colors of yellow (Y), magenta (M), cyan (C) and black (K), respectively.

Constitutions and operations of the image forming portions are the substantially same except that the colors of the images to be formed are different from each other. Accordingly, in the case where the image forming portions are not particularly required to be distinguished from each other, suffixes Y, M, C and K added to reference numerals for representing elements for the associated colors are omitted, and the elements for the associated colors will be collectively described.

The image forming apparatus 100 includes four photosensitive drums 1 which are juxtaposed, and each of the photosensitive drums 1 is rotationally driven. At a periphery of the photosensitive drums 1, a scanner unit 3 for forming an electrostatic image on each of the photosensitive drums 1 by irradiating an associated photosensitive drum 1 with laser light on the basis of the image information is provided.

Further, at the periphery of the photosensitive drum 1, a developing unit 4 for developing the electrostatic image into a toner image is provided. Further, an intermediary transfer belt 5 for transferring the toner image from the photosensitive drum 1 onto a recording material 12 is provided opposed to the photosensitive drum 1.

The developing unit 4 develops the electrostatic image by depositing a toner, charged to the same polarity as a charge polarity of the photosensitive drum 1, on an image portion where an electric charge is attenuated by the exposure of the photosensitive drum 1 to light.

In this embodiment, the photosensitive drum 1 and process means such as the developing unit 4 are integrally assembled into a cartridge to form a process cartridge 7. The process cartridge 7 is detachably mountable to the image forming apparatus 100.

The intermediary transfer belt 5 contacts all the photosensitive drums 1 and rotates in an arrow B direction. The intermediary transfer belt 5 is stretched around a follower roller 51, a secondary transfer opposite roller 52 and a driving roller 53, which are used as a plurality of supporting members.

Further, in an inner peripheral surface side of the intermediary transfer belt 5, four primary transfer rollers 8 are juxtaposed so as to oppose the photosensitive drums 1. Each of the primary transfer rollers 8 presses the intermediary transfer belt 5 toward the photosensitive drum 1 to form a primary transfer portion N1 where the intermediary transfer belt 5 and the photosensitive drum 1 contact each other. Then, to the primary transfer roller 8, a bias of an opposite polarity to a normal charge polarity of the toner is applied, so that the toner image is primary-transferred onto the intermediary transfer belt 5.

In an outer peripheral surface side of the intermediary transfer belt 5, a secondary transfer roller 9 is provided at a position opposing the secondary transfer opposite roller 52. The secondary transfer roller 9 press-contacts the intermediary transfer belt 5 toward the secondary transfer opposite roller 52 to form a secondary transfer portion N2 where the intermediary transfer belt 5 and the secondary transfer roller 9 contact each other. Then, to the secondary transfer roller 9, a bias of an opposite polarity to the normal charge polarity of the toner is applied, so that the toner images are secondary-transferred from the intermediary transfer belt 5 onto the recording material 12.

During image formation, first, the surface of the photosensitive drum 1 is charged, and then the surface of the charged photosensitive drum 1 is subjected to scanning-exposure to laser light, depending on the image information, emitted from the scanner unit 3, so that the electrostatic image is formed on the photosensitive drum 1 correspondingly to the image information.

Then, the electrostatic image formed on the photosensitive drum 1 is developed into the toner image by the developing device 4. The toner image formed on the photosensitive drum 1 is primary-transferred onto the intermediary transfer belt 5 by the action of the primary transfer roller 8.

For example, during full-color image formation, the above-described process is successively performed at the image forming portions SY, SM, SC and SK, and then the toner images of the respective colors are primary-transferred superposedly onto the intermediary transfer belt 5.

Thereafter, in synchronism with movement of the intermediary transfer belt 5, the recording material 12 is fed to the secondary transfer portion N2, and by the action of the secondary transfer roller 9 contacting the recording material 12 toward the intermediary transfer belt 5, the four color toner images are secondary-transferred collectively from the intermediary transfer belt 5 onto the recording material 12.

The recording material 12 on which the toner images are transferred is fed to a fixing device 10, and then is heated and pressed, so that the toner images are fixed on the recording material 12.

In this embodiment, an example using a one-component non-magnetic toner as the developer will be described, but the following constitution may also be employed. Specifically, in the case where a one-component developing device for performing development using a one-component magnetic toner is used, a one-component magnetic toner is to be supplied as the developer. Further, in the case where a two-component developing device for performing development using a two-component developer in which a magnetic carrier and a non-magnetic toner are mixed, a non-magnetic toner is supplied as the developer. In this case, a constitution in which also the magnetic carrier is supplied as the developer together with the non-magnetic toner may also be employed.

### (Structure of Process Cartridge)

Next, a structure of the process cartridge 7 to be mounted in the image forming apparatus 100 will be described.

With respect to structures and operations of the developing unit and the process cartridge, terms, such as upper, lower, vertical and horizontal, which represent directions refer to directions of these as seen in a normal operation state unless otherwise specified. That is, the normal operation state of the developing unit or the process cartridge is such a state that the unit or the cartridge is properly mounted in an image forming apparatus main assembly properly disposed and is capable of being subjected to the image forming operation.

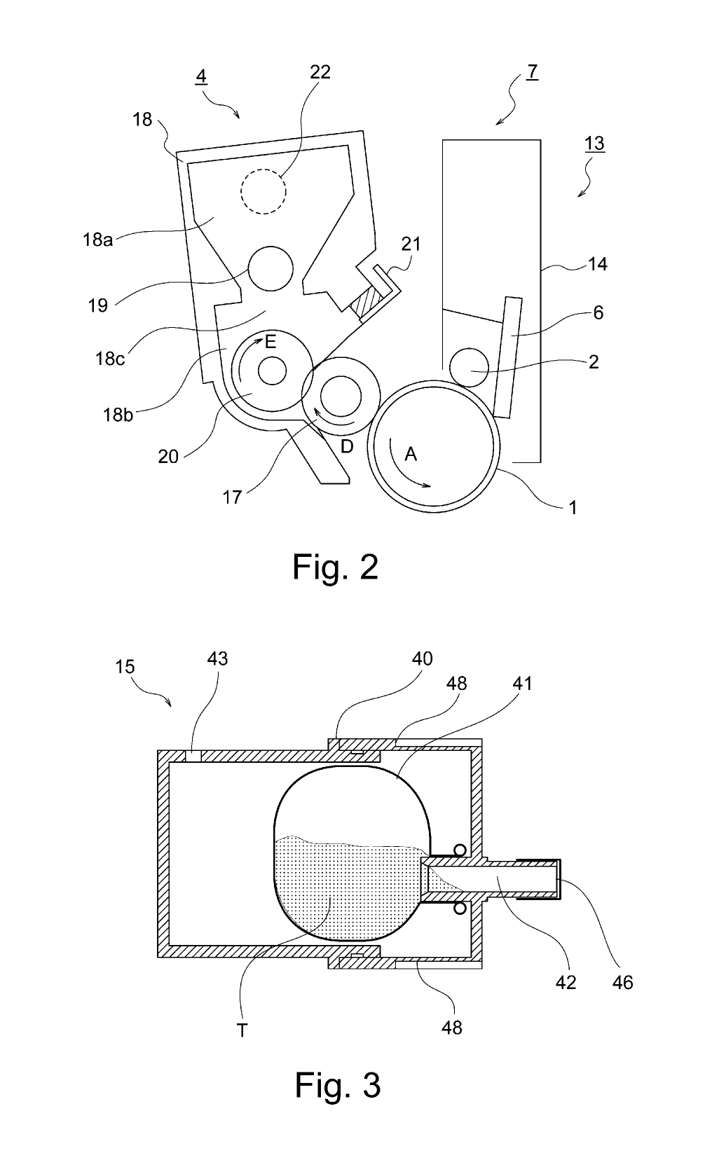

FIG. 2 is a schematic sectional view of the process cartridge 7. The structures and the operations of the process cartridges 7 for the respective colors are the substantially same.

The process cartridge 7 has a structure in which a photosensitive member unit 13 including the photosensitive drum 1 and the like and the developing unit 4 including a developing roller 17 and the like are integrally assembled. The photosensitive member unit 13 and the developing unit 4 use separate frames.

The photosensitive member unit 13 includes a frame 14 as a frame for supporting various elements (components) in the photosensitive member unit 13. In the frame 14, in addition to the photosensitive drum 1, the charging roller 2 and the cleaning member 6 and the like are provided. The charging roller 2 uniformly charges the surface of the photosensitive drum 1. The cleaning member 6 collects a transfer residual toner remaining on the surface of the photosensitive drum 1 after the development. The photosensitive drum 1 is rotationally driven in an arrow A direction.

On the other hand, the developing unit 4 includes a frame 18 as a frame for supporting various elements in the developing unit 4. The developing unit 4 includes the developing roller 17, which rotates in an arrow D direction in contact with the photosensitive drum 1, for carrying the developer. The developing roller 17 and the photosensitive drum 1 rotates so that their surfaces move, at their opposing portion (contact portion), in the same direction (directed from an upper side toward a lower side). Further, a rotational speed of the developing roller 17 is set so as to be about 1.3 times higher than a rotational speed of the photosensitive drum 1. The developing roller 17 is an elastic developing roller constituted by a core metal and a material, formed on the core metal, such as a low-hardness rubber material or foam member of silicone, urethane or a combination thereof.

Further, in the developing unit 4, a toner supplying roller (developer supplying roller) 20 which rotates in an arrow E direction and supplies the developer to the developing roller 17 is provided so as to contact the peripheral surface of the developing roller 17. The toner supply roller 20 and the developing roller 17 rotate so that their surfaces move in opposite directions at their opposing portion (contact portion). Further, the toner supplying roller 20 is constituted by providing an open cell foam member on an outer peripheral surface of an electroconductive core metal, and a surface rotational speed thereof was 0.85 times the surface rotational speed of the developing roller 17.

The frame 18 is provided with a developing blade 21 for regulating a thickness of the developer. The developing blade 21 is a metal-made leaf spring, and contacts the developing roller 17 at a predetermined contact pressure. The toner supplied onto the developing roller 17 is subjected to layer thickness regulation by the cleaning blade 21, and at the same time, electric charges are imparted to the toner by triboelectric charging. As a result, the toner is formed in a thin layer on the developing roller 17, and then is fed to a developing region.

Further, the toner carried as it is on the developing roller 17 without contributing to the development is scraped off from the surface of the developing roller 17 by friction with the toner supplying roller 20. Then, a part of the toner is supplied again, together with the toner supplied onto the toner supplying roller 20, onto the developing roller 17 by the toner supplying roller 20, and a remaining part of the toner is returned into the developing roller 18.

Further, the developing roller 18 includes a toner accommodating chamber 18a for temporarily accommodating the toner supplied from an outside of the frame 18 and a developing chamber 18b in which the developing roller 17 and the toner supplying roller 20 are provided. That is, the developing roller 18 constitutes a developer container.

The toner accommodating chamber 18a and the developing chamber 18b are partitioned by an opening 18c for permitting passing of the toner therethrough, and the toner supplied to the toner accommodating chamber 18a is fed to the developing chamber 18b by a stirring member 19 provided in the toner accommodating chamber 18a.

Further, the toner accommodating chamber 18a is provided with a toner inlet port for receiving the toner supplied from a toner cartridge 15.

In this embodiment, a constitution in which the toner supplied to the developing unit 4 is temporarily accommodated in the toner accommodating chamber 18a is employed, but a constitution in which the toner is directly fed to the developing chamber 18b.

### (Structure of Toner Cartridge)

Next, the toner cartridge 15 as a developer supply container in this embodiment will be described.

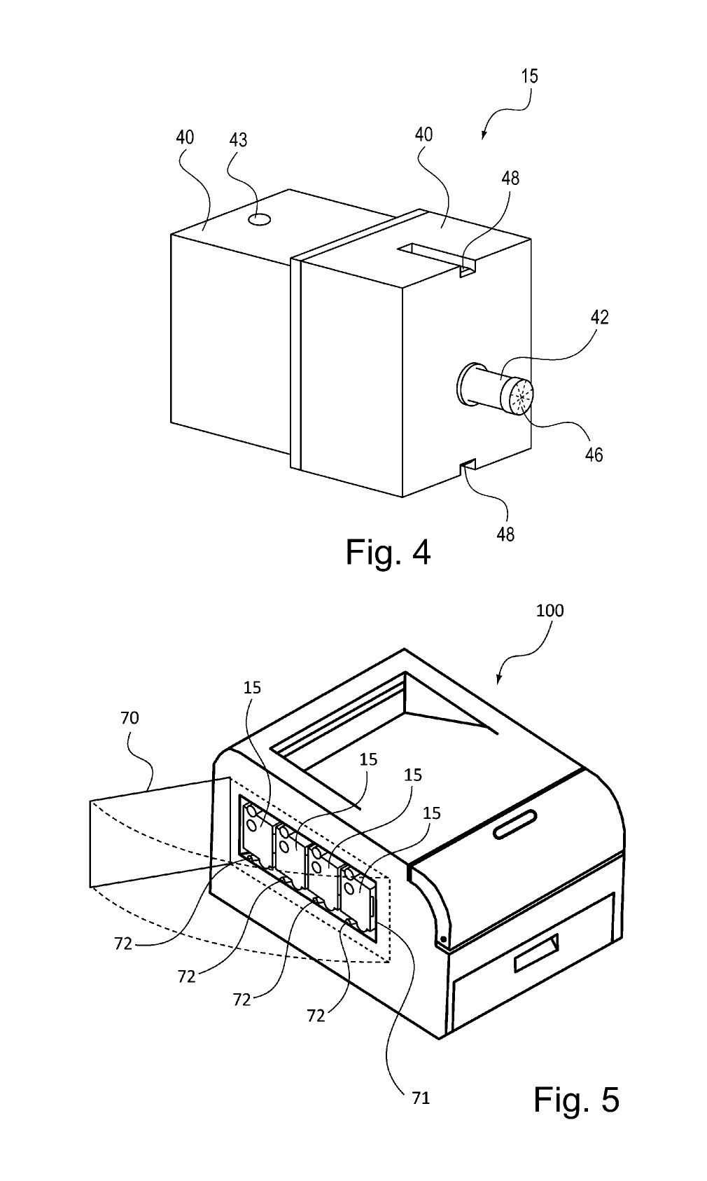

FIG. 3 is a schematic sectional view of the toner cartridge 15, and FIG. 4 is a schematic view of an outer appearance of the toner cartridge 15.

As shown in FIG. 3, the toner cartridge 15 includes a container frame 40 as a frame (casing) of supporting various elements in the toner cartridge 15 and a toner accommodating bag (developer accommodating bag) 41 having elasticity (elastic restoring force) for permitting accommodation of the toner T. The container frame 40 is provided with a toner discharging path 42, an air communication path 43 and a mounting guide 48.

The toner discharging path 42 is connected with the toner accommodating bag 41 in an inside of the container frame 40, and the toner in the toner accommodating bag 41 is discharged through the toner discharging path (developer discharging path) 42. The toner accommodating bag 41 is supplied by the container frame 40 by being connected with the toner discharging path 42. The air communication path 43 connects a space, between the container frame 40 and the toner accommodating bag 41, with an outside of the container, and maintains a pressure in the space between the container frame 40 and the toner accommodating bag 41 at an atmospheric (ambient) pressure.

In the thus-constituted toner cartridge 15, the toner in a predetermined amount is filled together with air in the toner accommodating bag 41 via the toner discharging path 42. After the toner filling is ended, a discharging path sealing member 46 is mounted to the toner discharging path 42 while maintaining expansion of the toner accommodating bag 41. The discharging path sealing member 46 maintains an airtight state in the toner accommodating bag 41 in a period from manufacturing of the toner cartridge 15 until the toner cartridge 15 is used.

As a material for the container frame 40, a material having rigidity to the extent that the material is not largely changed by a force from the inside or the outside may preferably be employed. In this embodiment, as the material for the container frame 40, a polystyrene resin is employed. As the material used, if the material is capable of resisting the forces from the inside and the outside, it is also possible to use, e.g., resins such as ABS, polyester, polyethylene and polypropyrene, and the container frame 40 may also be formed of metal. In this embodiment, an inside volume of the container frame 40 is 120 cc.

As the material for the toner accommodating bag 41, it is possible to use various resins, which are elastic materials capable of expansion and contraction, including various elastomers such as polyamide, polyurethane, polyamide elastomer, polyester elastomer, polyurethane elastomer, fluorine-containing elastomer, silicone rubber and latex rubber. Alternatively, materials such as combinations each of two or more species of these materials can be used. These materials are high in permeability in general. For that reason, the air filled together with the toner in the toner accommodating bag 41 gradually leaks out from the toner accommodating bag 41, so that the toner accommodating bag 41 contracts.

Particularly, in order to enhance toner discharging power, it is preferable that a material having a large elongation and a large restoring force is employed. As the material having such properties, there is an entropy elastic member, and in this embodiment, a latex rubber as a species of the entropy elastic member is employed.

As the toner accommodating bag 41, a balloon-like bag of 5.5 (cm³) in volume and 0.2 (mm) in thickness in a natural state was used. Further, the toner accommodating bag 41 is expandable in the container frame 40 to 120 cc which is equal to the inside volume of the container frame 40.

The toner accommodated in the toner accommodating bag 41 is a non-magnetic toner manufactured by a suspension polymerization, and has an average diameter of about 6.5 μm. In order to modify a surface property, silicone oxide particles of about 20 nm are uniformly deposited on the toner surface in an amount which is about 1.5% of the toner weight. Here, an average particle size of the toner is a volume-average particle size measured by a laser diffraction-type particle size distribution measuring device (“LS-230”, manufactured by Beckman Coulter, Inc.).

A bulk density of the toner is 0.32 (g/cm³) during flowing and is 0.50 (g/cm³) during pressure application. The bulk density of the toner during the flowing was measured in accordance with JIS-K-5101-12-1. The toner shows a large change in bulk density with time, and therefore the measurement was made in such a manner that a time from start of entrance of the toner into a receiver until the toner heaped up on the receiver is leveled off is 10 seconds.

Further, an apparent density defined in JIS-K-5101-12-1 is a synonym for the bulk density. The bulk density of the toner during the pressure application was measured by a powder rheometer (“FT4, manufactured by Malvern Instruments Ltd.). The pressure was 10 (kPa) substantially equal to a contraction pressure of the toner accommodating bag 41. In this embodiment, 12.5 (g) of the toner was filled in the toner accommodating bag 41.

The toner discharging path 42 may preferably be 4 mm or more in inner diameter from the viewpoint of a flow path resistance when the toner is discharged. On the other hand, the air communication path 43 is a path through which the air goes in and out, and the influence of the flow path resistance thereon is small. For that reason, the inner diameter of the air communication path 43 can be made smaller than the inner diameter of the toner discharging path 42, and may desirably be 2 mm or more. In this embodiment, specifically, the toner discharging path 42 is 6 mm in inner diameter, and the air communication path 43 is 4 mm in inner diameter.

### (Toner Cartridge Mounting Operation)

Next, an operation in which the toner cartridge 15 is mounted in the image forming apparatus 100 and then the toner is supplied from the toner cartridge 15 into the toner accommodating chamber 18a will be described.

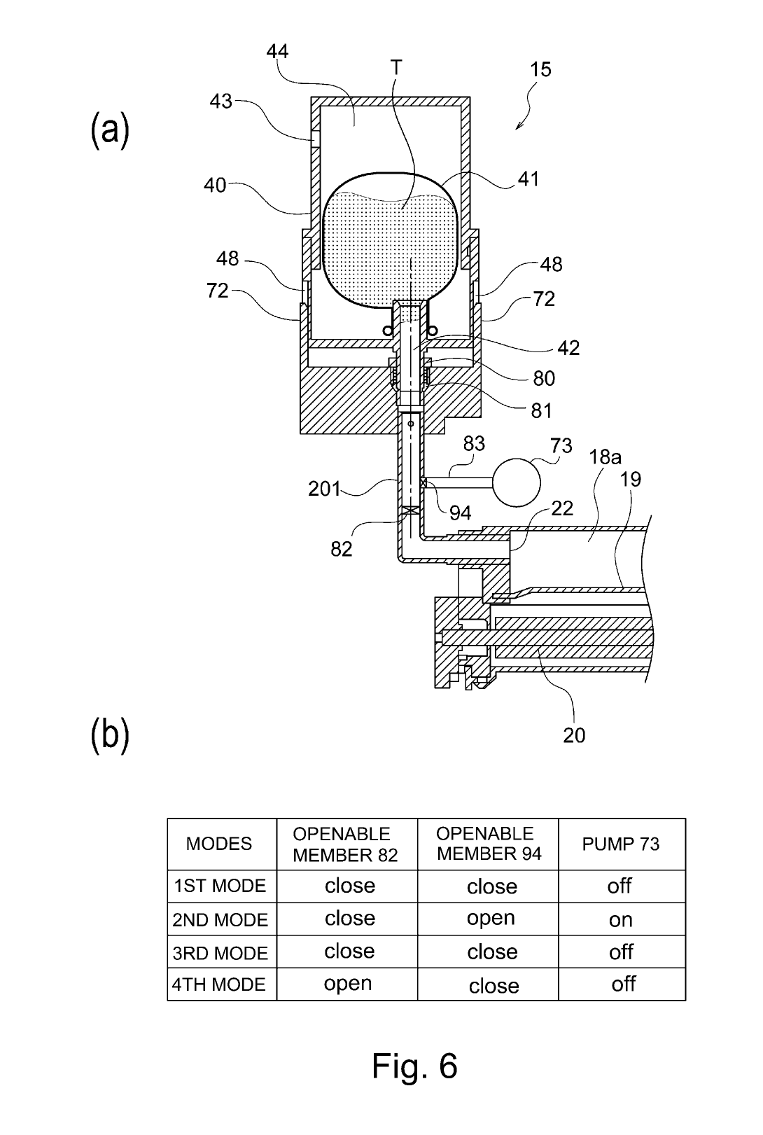

FIG. 5 shows an outer appearance of the image forming apparatus 100.

As shown in the figure, when an operator opens a front door 70 which is a part of an outer casing of the image forming apparatus 100, an insertion opening 71 for permitting mounting of the toner cartridges 15 appears. The image forming apparatus 100 is provided with mounting ribs 72 constituting guides for mounting the toner cartridges 15, and mounting guides 48 provided on the container frames 40 are slid and inserted along the mounting ribs 72.

In FIG. 6, (a) is a sectional view showing a mounting state between the toner cartridge 15 and the image forming apparatus 100, and (b) is a table showing operations in modes of the image forming apparatus 100.

As shown in (a) of FIG. 6, when the toner cartridge 15 is slid and inserted into the image forming apparatus 100, the toner discharging path 42 enters a toner discharging path receiving portion 80 provided in the image forming apparatus 100. Then, a discharging path sealing member 46 is broken, so that the toner discharging path 42 is connected with a toner inlet port 22 provided in the toner accommodating chamber 18a. As a result, it is possible to supply the toner T from the toner cartridge 15 into the toner accommodating chamber 18a. Further, the toner discharging path 42 is engaged with a receiving and sealing member 81 provided in the toner discharging path receiving portion 80.

The receiving and sealing member 81 prevents not only toner scattering during toner supply but also disconnection of the toner cartridge 15 by friction with the toner discharging path 42.

In this embodiment, as the discharging path sealing member 46, a composite film of a resin material and a metal foil was used. In order to facilitate breakage of the discharging path sealing member 46 by the toner discharging path receiving portion 80, it is preferable that a V-shaped cut-away groove is molded at the surface of the discharging path sealing member 46 in advance. Further, an oil seal is used as the receiving and sealing member 81, but as another example, a felt material or a foam sponge material may also be used so as to be compressed in a certain amount.

The toner discharging path receiving portion 80 and the toner inlet port 22 are connected by a toner guiding path 201. In the toner guiding path 201, an openable member 82 for opening and closing the toner guiding path 201 is provided. Further, between the toner discharging path receiving portion 80 and the openable member 82, an air injection path 83 (second connecting path) communicating with a pump 73 (pressure generating means) is provided. To the air injection path 83, an openable member 94 is mounted. The pump 73 is operated (actuated) in a state in which the member 94 is open, whereby the air is supplied into the toner accommodating bag 41 via the air injection path 83 and the toner discharging path 42.

Further, the toner discharging path 42 is mounted so as to be positioned vertically under the toner accommodating bag 41 in the case where the toner cartridge 15 is mounted in the main assembly of the image forming apparatus 100. As a result, when the pump 73 sends the air into the toner accommodating bag 41, the toner is stirred, and fluidization of the toner is accelerated. When the toner is discharged from the inside of the toner accommodating bag 41, the toner is discharged preferentially earlier than the air, and therefore the toner discharging power is enhanced.

### (Toner Supplying Operation)

Next, steps of an operation for supplying the toner from the toner cartridge 15 into the toner accommodating chamber 18a will be sequentially described.

In FIG. 6, (b) shows an operation in a control mode of the openable member 82, the openable member 94 and the pump 73.

Mode 1 is an initial state, in which both the openable members 82 and 84 are in a closed state, and the pump 73 is in rest (“off”).

In subsequent mode 2, the member 82 is kept in the closed state, and the member 94 is switched into an open state. Then, the pump 73 is driven (“on”), and thus the pump 73 starts supply of the air. The air flows into the toner accommodating bag 41, and thus expands the toner accommodating bag 41. When the toner accommodating bag 41 expands until the toner accommodating bag 41 contacts the container frame 40, the mode 2 is switched into mode 3, so that the member 94 is closed, and the pump 73 is stopped.

In the mode 3, both the openable members 82 and 94 are closed, and the toner accommodating bag 41 is kept in the expanded state.

Then, when the openable member 82 is opened in an operation in mode 4, the toner accommodating bag 41 contracts by the restoring force, so that the toner and the air which are contents of the toner accommodating bag 41 are discharged. The toner is supplied together with the air into the toner accommodating chamber 18a via the toner discharging path 42 and the toner inlet port 22.

When the discharge of the toner from the toner accommodating bag 41 is ended, the operation in the mode is returned to the operation in the mode 1 as the initial state in order to prepare for subsequent toner discharge.

### (Pump Load)

In this embodiment, as the toner accommodating chamber 41, the latex rubber which is one species of the entropy elastic member is used. A relationship between an inside (internal) pressure and a radius when the balloon-like bag formed of such an elastic material capable of expansion and contraction is expanded will be considered.

Assuming that the bag expands in a spherical shape, the relationship between the inside pressure and stress of the bag is given by Laplace's law represented by the following formula 1:

Δp=2σt/r (formula 1),

where Δp is the inside pressure, σ is the stress of the bag, t is the thickness of the bag, and r is the radius of the bag.

A constitutive law of a thin spherical surface is given by the following formula 2:

σ=Eε/(1−ν) (formula 2),

where E is Young's modulus, ν is Poisonn's ratio, and ε is distortion.

Further, the distortion when the spherical surface expands is given by the following formula 3:

E=(2πr−2πr₀)/2πr₀=(r−r₀)/r₀ (formula 3),

where r₀ is an initial radius of the bag.

Assuming that the thickness of the spherical surface is constant over the entire area, a change in thickness when the spherical surface expands is given by the following formula 4:

4πr²t=4πr₀²t₀, i.e., t=r₀2t₀/r² (formula 4),

where t₀ is an initial thickness of the bag.

From the above formulas, when the relationship between the inside pressure and the radius of the bag is obtained, the following formula 5 holds:

Δp=k×(r−r₀)/r³ where k=2Er₀t₀/1−ν) (formula 5).

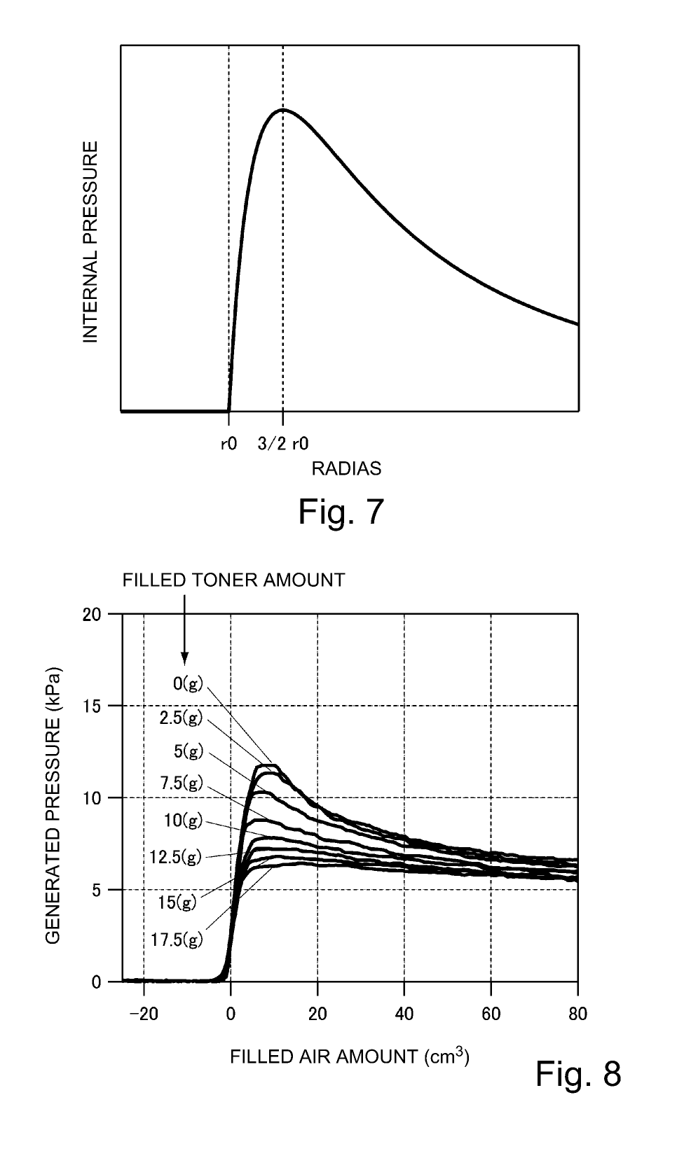

FIG. 7 is a graph showing the formula 5.

As shown in the figure, when the bag formed of the elastic material capable of expansion and contraction is expanded, it is understood that a maximum value of the pressure exists. When the radius of the bag becomes larger than the radius providing the maximum value of the pressure, a pressure necessary to expand the bag lowers. In this embodiment, an ideal condition such that the bag expands in the spherical shape and that the thickness of the bag is constant is described, but the above-described maximum value of the pressure also exits in a bag actually formed of the elastic material capable of expansion and contraction.

The air was filled in the toner accommodating bag 41 by the pump 73, and then a generated pressure by the pump 73 relative to a filled toner amount when the toner accommodating bag 41 was expanded was measured. The filled toner amount was changed from 0 (g) to 17.5 (g). The measurement was started from a state in which the air leaked out from the toner accommodating bag 41 and the toner accommodating bag 41 completely contracted.

FIG. 8 is a graph showing a relationship between a filled air amount and the generated pressure by the pump 73 in the case where the filled toner amount is changed.

As shown in the figure, in the case where the filled toner amount is 0 (g), similarly as in the case of FIG. 7, a large maximum value exists. The filled air amount at this time, i.e., a volume of the toner accommodating bag 41 is 8.8 (cm³). In the case where the measurement is made in a state in which the toner is filled in the toner accommodating bag 41, when the filled toner amount exceeds 5 (g), a maximum pressure of the pump 73 starts decrease.

The reason why the maximum pressure decreases is that the toner supports the toner accommodating bag 41 so as to prevent the toner accommodating bag 41 from contracting to not more than the radius providing the maximum value of the pressure.

The fluidization toner amount necessary to decrease the maximum pressure of the pump 73 will be considered. The toner in the toner accommodating bag 41 before the air is filled in the toner accommodating bag 41 is in a state in which the toner is pressed by the restoring force of the toner accommodating bag 41. Therefore, as a toner density, the bulk density of 0.50 (g/cm³) during the pressure application is used.

That is, when the toner in an amount obtained by multiplying the bulk density during the pressure application by a volume when the pressure of the toner accommodating bag 41 is the maximum value, the toner accommodating bag does not contract to a radius which is not more than the radius providing the maximum value of the pressure thereof.

In this case, when a specific toner amount is calculated, the filled toner amount necessary to supply the toner accommodating bag 41 of 8.8 (cm³) in volume providing the maximum value of the pressure is as follows:

8.8 (cm³)×0.50 (g/cm³)=4.4 g.

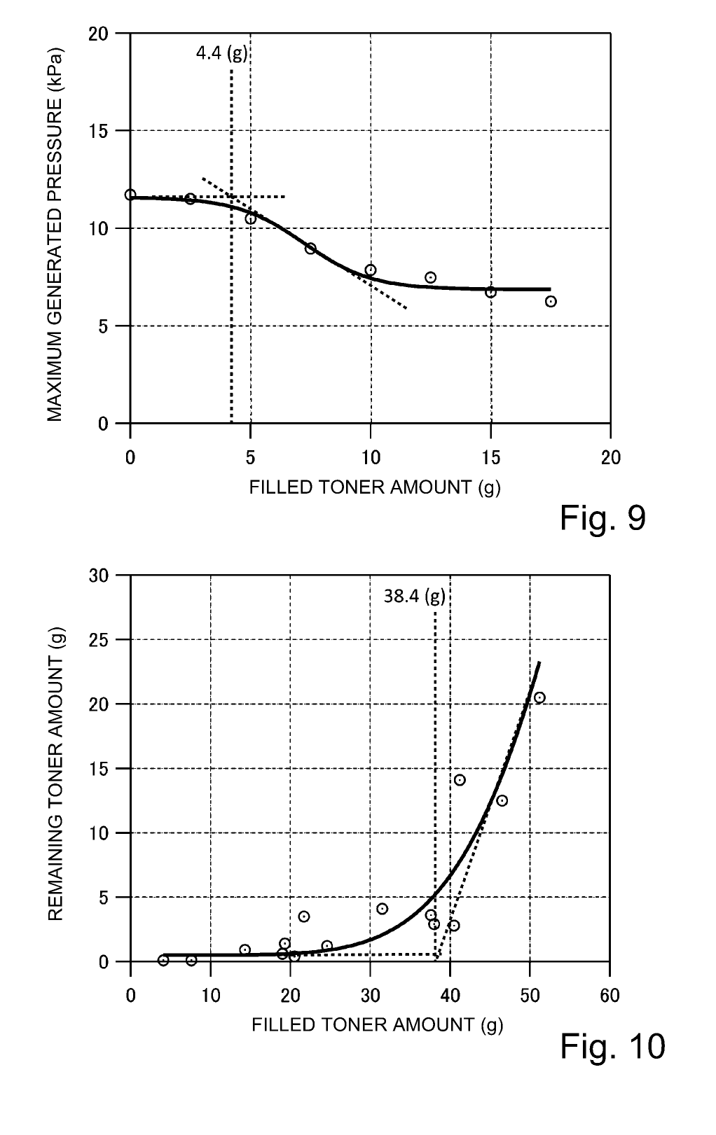

FIG. 9 is a graph showing a relationship between the filled toner amount and a maximum generated pressure by the pump 73.

As shown in the figure, from the neighborhood of a point exceeding the filled toner amount of 4.4 (g), it is possible to confirm that the maximum generated pressure by the pump 73 is decreased.

As in this embodiment, the maximum generated pressure by the pump 73 is largely decreased also in the case where the filled toner amount is 12.5 (g), so that the maximum generated pressure by the pump during the expansion of the toner accommodating bag 41 was able to be reduced.

That is, in this embodiment, in the toner accommodating bag 41, the developer in the amount obtained by the product of the developer bulk density, in the case where the developer is pressed at the predetermined pressure, and the volume of the toner accommodating bag 41 in which the contraction pressure has the maximum value is accommodated.

That is, in the toner accommodating bag 41, the toner in the amount in which the volume of the toner accommodating bag 41 is not less than the volume in which the contraction pressure of the toner accommodating bag 41 has the maximum value is accommodated.

As described above, the predetermined pressure is appropriate when the predetermined pressure is 10 (kPa) substantially equal to the contraction pressure of the toner accommodating bag 41, but may also be another pressure value in the case where the change in toner density is not so large. That is, the developer bulk density may only be checked at a pressure value within a range such that the toner amount when the contraction pressure of the toner accommodating bag 41 has the maximum value is accurately obtained.

### (Toner Discharging Power)

The toner accommodating bag 41 formed of the elastic material capable of expansion and contraction changes in volume by the expansion. Further, the toner changes in bulk density depending on the content of the air. For that reason, the filled toner amount into the toner accommodating bag 41 can be various values. However, when a ratio of the air to the toner is decreased, flowability of the toner lowers, so that the toner discharging performance lowers. Therefore, there is a need to enhance the toner discharging performance by enhancing the flowability of the toner during the toner discharge.

When the toner in the toner accommodating bag 41 is discharged in a state in which the filled toner amount is changed from 5 (g) to 50 (g), the weight of the toner remaining in the toner accommodating bag 41 was measured. The measurement was started from a state in which the air leaked out from the toner accommodating bag and then the toner accommodating bag completely contracted.

FIG. 10 is a graph showing a relationship between the filled toner amount and the weight of the toner remaining in the toner accommodating bag 41 when the toner in the toner accommodating bag 41 is discharged in the state in which the filled toner amount is changed from 5 (g) to 50 (g).

As shown in the figure, when the filled toner amount is gradually increased, the remaining toner amount in the toner accommodating bag 41 abruptly increases from a certain value. In order to discharge the toner from the toner accommodating bag 41, there is a need to contain the air in a proper amount in the toner to fluidize the toner sufficiently. A maximum volume of the toner accommodating bag 41 is limited by an inside volume of the container frame 40. The maximum volume in the case where the toner accommodating bag 41 is not incorporated in the container frame 40 is limited by a toner accommodating bag breaking volume or a limit volume in which the toner accommodating bag 41 can expand at the maximum generated pressure by the pump 73. For that reason, when the toner is excessively filled in the toner accommodating bag 41, the air necessary to fluidize the toner cannot be filled, and therefore the remaining toner amount increases.

Next, the filled toner amount in which the toner in the toner accommodating bag 41 can be fluidized will be considered. The bulk density during flow of the fluidized toner can be measured in accordance with the JIS-K-5101-12-1.

In this measuring method, a receiver having a predetermined volume is used. Then a sieve is placed on a funnel, and a spoon of a sample is placed on the sieve. Then, the entire surface of the sieve is lightly swept uniformly with a brush, and then the sample passed through the sieve is received by the receiver. This operation is repeated until the sample is heaped up on the receiver. The heaped-up portion of the sample is cut by a spatula, and then the weight of the receiver in which the sample is contained is measured. As a result, the bulk density is obtained from the volume of the receiver and the weight of the sample held in the receiver.

Accordingly, by the product of the bulk density of the toner during flowing and the inside maximum volume of the toner accommodating bag 41, it is possible to obtain the filled toner amount in which the toner in the toner accommodating bag 41 can fluidize.

In the case of this embodiment, the filled toner in which the toner in the toner accommodating bag 41 can fluidize can be obtained in the following manner from the bulk density of 0.32 (g/cm³) during the flowing of the toner and the maximum inside volume of 120 (cm³) of the toner accommodating bag 41.

120 (cm³)×0.32 (g/cm³)=38.4 (g)

When FIG. 10 is seen, from the neighborhood exceeding 38.4 (g) in filled toner amount, it is possible to confirm that the remaining toner amount abruptly increases.

In the case where the filled toner amount is 12.5 (g), in the remaining toner amount of 1 (g) or less, it was possible to discharge the toner without almost leaving the toner in the toner accommodating bag 41.

Accordingly, in order to lower the maximum pressure of the pump 73 and to decrease the remaining toner amount during the discharge of the toner by the flowability of the toner, the amount of the toner to be accommodated in the toner accommodating bag 41 was preferably be set as follows. That is, the toner amount may only be required so as to be larger than the amount obtained by multiplying the bulk density during the pressure application by the volume when the pressure of the toner accommodating bag has the maximum value and so as to be smaller than the amount obtained by multiplying the bulk density during the flowing of the toner by the maximum inside volume of the toner accommodating bag 41.

That is, in the toner accommodating bag 41, the developer in an amount not more than the amount obtained by the product of the bulk density during the flowing of the toner and the volume of the toner accommodating bag 41 immediately before start of the discharge of the toner is accommodated.

### Second Embodiment

Next, an image forming apparatus in Second Embodiment as another embodiment of the present invention will be described.

A constitution in this embodiment is basically in accordance with the constitution of the image forming apparatus in First Embodiment, but the following point is different from First Embodiment. Incidentally, portions identical and similar to those in First Embodiment are represented by the same reference numerals or symbols and will be omitted from redundant description.

### (Structure of Toner Cartridge)

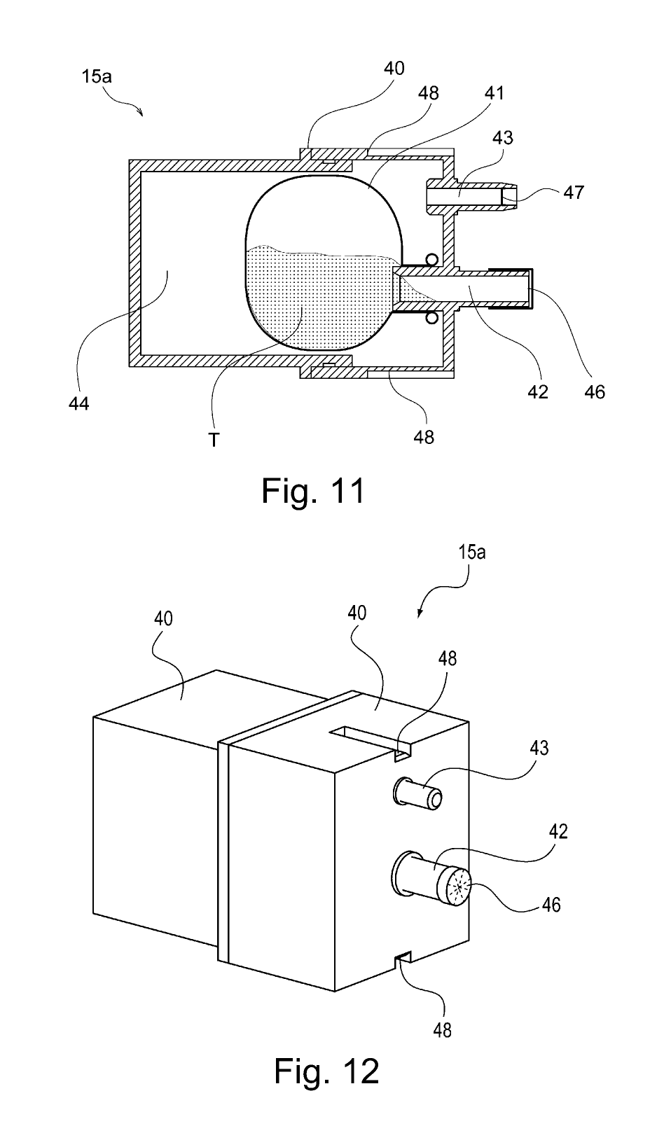

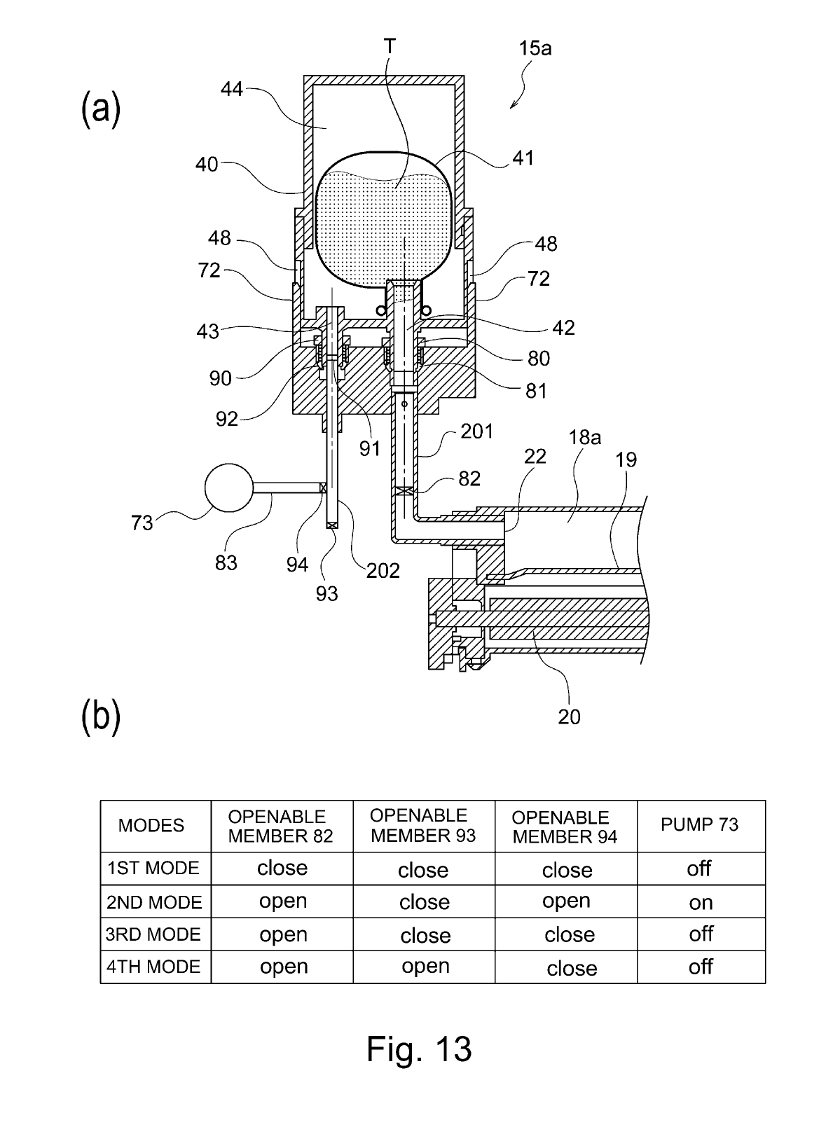

FIG. 11 is a schematic sectional view of a toner cartridge 15a in this embodiment, and FIG. 12 is a schematic view of an outer appearance of the toner cartridge 15a.

A space between the container frame 40 and the toner accommodating bag 41 constitutes a closed space with the air communication path 43 as an inlet and outlet port, and forms an airtight chamber 44.

A step of filling the toner into the thus-constituted toner cartridge 15a by a toner filling device (not shown) will be described.

The toner T in a predetermined amount is filled together with the air into the toner accommodating bag 41 via the toner discharging path 42. As the toner is gradually filled, the toner accommodating bag 41 expands to discharge the air inside the airtight chamber 44 through the air communication path 43. When the toner filling is ended, a thin film sealing member (first openable means) 47 is mounted in the air communication path 43 while maintaining the expansion of the toner accommodating chamber 41, thus sealing the airtight chamber 44 to place the airtight chamber 44 in an airtight (sealed) state. As a result, even when the discharging path sealing member 46 is mounted to the toner discharging path 42, the toner accommodating bag 41 does not contract.

This is based on the following mechanism. The toner accommodating bag 41 contracts by a restoring force thereof. However, when the toner accommodating bag 41 contracts, the air pressure in the airtight chamber 44 is in a state (negative pressure state) in which the air pressure is lower than the ambient (atmospheric) pressure. As a result, the restoring force of the toner accommodating bag 41 and a force due to a pressure different between the toner accommodating bag 41 and the airtight chamber 44 are balanced with each other, so that the toner accommodating bag 41 does not contract.

Thereafter, the discharging path sealing member 46 is mounted to the toner discharging path 42. The discharging path sealing member 46 prevents the toner inside the toner accommodating bag 41 from discharging through the toner discharging path 42 in a period from manufacturing to use of the toner cartridge 15a.

In this embodiment, the volume of the container frame 40 is 120 cc, and the filled toner amount is 12.5 (g).

The pressure in the airtight chamber 44 during the manufacturing is about −10 kPa relative to the ambient pressure. As the toner accommodating bag 41, the latex rubber having a high air permeability is used. For that reason, the air filled together with the toner in the toner accommodating bag 41 gradually leaks out from the toner accommodating bag 41 into the airtight chamber 44. For this reason, with a lapse of the time from the manufacturing to the use of the toner cartridge 15a, the pressure difference between the inside of the toner accommodating bag 41 and the airtight chamber 44 becomes small, so that the toner accommodating bag 41 gradually contracts. With the contraction of the toner accommodating bag 41, the bulk density of the toner gradually increases.

### (Toner Supplying Operation)

Next, an operation in which the toner cartridge 15a is mounted in a main assembly of the image forming apparatus 100 and then the toner is supplied from the toner cartridge 15 into the toner accommodating chamber 18a will be described.

In FIG. 13, (a) is a sectional view showing a mounting state between the toner cartridge 15a and the main assembly of the image forming apparatus 100, and (b) is a table showing operations in modes of the image forming apparatus 100.

As shown in (a) of FIG. 13, when the toner cartridge 15a is slid and inserted into the main assembly of the image forming apparatus 100, the toner discharging path 42 enters a toner discharging path receiving portion 80 provided in the image forming apparatus 100. Then, a discharging path sealing member 46 is broken, so that the toner discharging path 42 is connected with a toner inlet port 22 provided in the toner accommodating chamber 18a.

Similarly, the air communication path 43 enters the air communication path receiving portion 90, and then the thin film sealing member 47 is broken by a seal breaking member 91, so that the air communication path 43 is connected to the pump 73 via the air communication path 83 and thus the toner is dischargeable. The air communication path receiving portion 90 engageable with the air communication path 43 is provided with an air sealing member 92 for maintaining an airtight property between the air communication path receiving portion 90 and the air communication path 43.

In the case where the toner cartridge 15a is mounted in the main assembly of the image forming apparatus 100, a toner guiding path 201 for connecting the toner discharging path 42 with the toner inlet port 22 is provided. Further, the toner guiding path 201 is provided with the openable member 82 for opening and closing the toner guiding path 201. On the other hand, the air communication path 43 is provided with an air guiding path 202 (first connecting path). The air guiding path 202 is provided with the openable member 93 (second openable means). Further, between the air communication path receiving portion 90 of the air guiding path 202 and the openable member 93, an air injecting path 83 (second connecting path) is provided. The air injecting path 83 is provided with an openable member 94 for opening and closing the air injecting path 83.

A table of (b) of FIG. 13 shows an operation in a control mode of the openable member 82, the openable member 93, the member 94 and the pump 73.

Next, an operation for supplying the toner from the toner cartridge 15a into the toner accommodating chamber 18a will be described.

Mode 1 shown in (b) of FIG. 13 is an initial state, in which all the openable members 82, 93 and 94 are in a closed state, and the pump 73 is in rest (“off”). In this state, the airtight chamber 44 maintains the negative pressure state, so that the toner accommodating bag 41 is kept as it is.

In subsequent mode 2, the openable member 82 and the openable member 94 are switched into an open state. Then, the pump 73 is driven (“on”), so that the air is discharged (evacuated) from the airtight chamber 44 via the air injecting path 83, the air guiding path 202, and the air communication path 43. When the force due to the pressure different between the toner accommodating bag 41 and the airtight chamber 44 exceeds the restoring force of the toner accommodating bag 41, the toner accommodating bag 41 expands. When the toner accommodating bag 41 expands until the toner accommodating bag 41 contacts the container frame 40, the mode 2 is switched into mode 3, so that the member 94 is closed, and the pump 73 is stopped.

In the mode 3, the force due to the pressure difference between the toner accommodating bag 41 and the airtight chamber 44 and the restoring force of the toner accommodating bag 41 are balanced with each other, so that the toner accommodating bag 41 is kept in the expands state.

Then, when the openable member 93 is opened in an operation in mode 4, the pressure in the airtight chamber 44 is returned to the same ambient pressure as that in the toner accommodating bag 41 to eliminate the pressure difference between the toner accommodating bag 41 and the airtight chamber 44. Then, the toner accommodating bag 41 contracts by the restoring force, so that the toner which is contents of the toner accommodating bag 41 is discharged together with the air. The toner and the air are supplied into the toner accommodating chamber 18a via the toner discharging path 42, the toner guiding path 201 and the toner inlet port 22.

When the discharge of the toner from the toner accommodating bag 41 is ended, the operation in the mode is returned to the operation in the mode 1 as the initial state in order to prepare for subsequent toner discharge.

### (Pump Load)

In this embodiment, the pump 73 is connected to the airtight chamber 44 via the air injecting path 83, the air guiding path 202 and the air communication path 43. The pressure in the toner accommodating bag 41 and the pressure in the airtight chamber 44 are merely different in sign and are equal to each other in absolute value. For that reason, similarly as in First Embodiment, when the toner supplies the toner accommodating bag 41 so that the toner accommodating bag 41 does not contract to the radius which is not more than the radius at which the pressure in the toner accommodating bag 41 has the maximum value, the maximum pressure of the pump 73 decreases. In this case, however, the sign of the pressure is reverse.

That is, when the toner in an amount obtained by multiplying the bulk density during the pressure application by a volume when the pressure of the toner accommodating bag 41 is the maximum value, the toner accommodating bag does not contract to a radius which is not more than the radius providing the maximum value of the pressure thereof.

Specifically, similarly as in First Embodiment, the toner in the amount of 4.4 (g) or more may only be required to be sealed in the toner accommodating bag 41.

The generated pressure by the pump 73 relative to an air discharge amount when the air in the airtight chamber 44 is discharged by the pump 73 to expand the toner accommodating bag 41 was measured. The measurement was made in the filled toner amounts of 0 (g) and 12.5 (g). Further, the measurement was started from a state in which the air leaked out from the toner accommodating bag 41 and thus the toner accommodating bag 41 completely contracts.

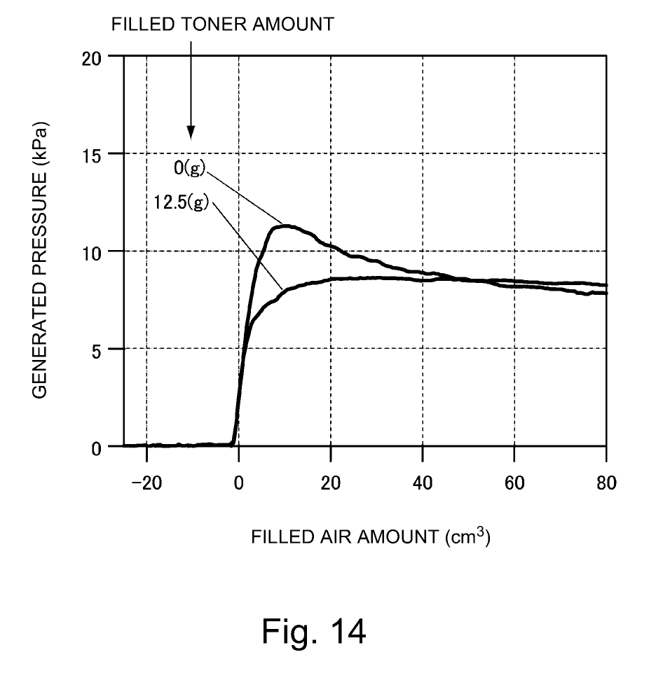

FIG. 14 is a graph showing a relationship between the filled toner amount and the generated pressure by the pump 73 in the case where the filled toner amount is 0 (g) and 12.5 (g).

As shown in the figure, similarly as in First Embodiment, when the filled toner amount is 0 (g), a large maximum value of the pressure exists, so that the maximum of the pump 73 is large.

As in this embodiment, the maximum value of the pressure of by the pump 73 is largely decreased in the case where the filled toner amount is 12.5 (g), so that the maximum generated pressure by the pump during the expansion of the toner accommodating bag 41 was able to be reduced.

### (Toner Discharging Power)

Also in this embodiment, in order to discharge the toner accommodated with toner accommodating bag 41, there is a need that the air in a proper amount is incorporated in the toner and thus the toner is sufficiently fluidized. This is also similar to First Embodiment and specifically the inside volume of the container frame 40 is 120 (cc), and therefore when the filled toner amount is 38.4 (g) or less the toner in the toner accommodating bag 41 can be fluidized.

As in this embodiment, in the case where the filled toner amount is 12.5 (g), the remaining toner amount is 1 (g) or less, so that it was possible to discharge the toner without almost having the toner in the toner accommodating bag 41.

Finally, the constitutions and effects of the above-described embodiments are summarized as follows. In the embodiments, in the developer accommodating bag, the developer in the amount in which the volume of the developer accommodating bag is not less than the volume in which the contraction pressure of the developer accommodating bag has the maximum value is accommodated.

For this reason, the volume is not less than the volume in which the contraction pressure of the developer accommodating bag has the maximum value, and therefore a load exerted on the pressure generating means can be reduced, and the pressure generating means can be downsized.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 216064/2013 filed Oct. 17, 2013, which is hereby incorporated by reference.

What is claimed is:

1. A developer supply container, detachably mountable to a main assembly of an image forming apparatus for forming an image with a developer, for supplying the developer to the main assembly, said developer supply container comprising:
a developer accommodating bag, having an elastic restoring force, for accommodating the developer; and
a developer discharging path for discharging, when said developer accommodating bag is mounted in the main assembly, the developer accommodated in said developer accommodating bag to the main assembly,
wherein when said developer accommodating bag is mounted in the main assembly, said developer accommodating bag is expandable by pressure generating means provided in the main assembly, and
wherein an amount of the developer accommodated in said developer accommodating bag is such that by accommodation of the developer, a volume of said developer accommodating bag is not less than a volume when a contraction pressure of said developer accommodating bag has a maximum value.

2. A developer supply container according to claim 1, wherein in said developer accommodating bag, the developer in an amount not less than an amount obtained by the product of a bulk density of the developer when the developer is pressed at a predetermined pressure and a volume in which the contract pressure of said developer accommodating bag is the maximum value is accommodated.

3. A developer supply container according to claim 2, wherein the predetermined pressure is the maximum value of the contract pressure of said developer accommodating bag.

4. A developer supply container according to claim 1, wherein in said developer accommodating bag, the developer is an amount not more than an amount obtained by the product of a bulk density of the developer during flowing and a volume of said developer accommodating bag immediately before start of discharge of the developer is accommodated.

5. A developer supply container according to claim 1, wherein said developer accommodating bag is formed of a material having entropy elasticity.

6. A developer supply container according to claim 1, further comprising:
a container frame incorporating said developer accommodating bag;
an air communication path for connecting a space between said container frame and said developer accommodating bag with an outside of said developer supply container; and
first openable means for opening and closing said air communication path,
wherein when said first openable means is closed, the space is in a sealed state in which the developer accommodating bag is contracted by the elastic restoring force of the developer accommodating bag to maintain a negative pressure state in which an air pressure in the space is lower than an air pressure in an outside of said developer supply container, and
wherein when said first openable means is open, the space communicates with the main assembly.

7. An image forming apparatus comprising:
a developer supply container according to claim 1; and
the pressure generating means.

8. An image forming apparatus comprising:
a developer supply container according to claim 1; and
the pressure generating means,
wherein the developer accommodating bag is expandable by injecting air into the developer accommodating bag through the developer discharging path under pressure generated by the pressure generating means.

9. An image forming apparatus comprising:
a developer supply container according to claim 6; and
the pressure generating means,
wherein the pressure generating means generates a negative pressure, and the developer accommodating bag is expandable by sucking air through the air communication path under the negative pressure.

10. An image forming apparatus according to claim 9, wherein the main assembly comprises:
a first connecting path for connecting the air communication path with an inside of the main assembly when said developer supply container is mounted in the main assembly;
a second openable means for opening and closing said first connecting path; and
a second connecting path for connecting said first connecting path, between said second openable means and a portion where said first connecting path is connected with the air communication path, with the pressure generating means,
wherein when said developer supply container is mounted in the main assembly and then said second openable means opened, air is introduced from the inside of the main assembly into the space, and the developer accommodating bag is contracted by the elastic restoring force to discharge the developer, accommodated in the developer accommodating bag, through the developer discharging path, and
wherein in a state in which said developer supply container is mounted in the main assembly and then said second openable means is closed, the developer accommodating bag is expandable by sucking out air in the space through the air communication path by the pressure generating means.
